(19) United States
(12) Patent Application Publication
(10) Pub. No.: US 2004/0022436 A1
(43) Pub. Date: Feb. 5, 2004

(54) System and method for data analysis of x-ray images

(76) Inventors: Paul Patti, Amherst, NY (US); Jinquan Li, Hamden, CT (US); Raghuveer M Rao, Pittsford, NY (US)

Correspondence Address: Christopher E Blank, Jaeckle Fleischmann & Mugel, Suite 200, 39 State Street, Rochester, NY, 14614-1310, US

(21) Appl. No.: 10/221,879

(22) PCT Filed: Mar. 16, 2001
(86) PCT No.: PCT/US01/08692

(51) Int. Cl. G06K 9/46; G06K 9/36

(52) U.S. Cl. 382/191; 382/240

(57) ABSTRACT

This invention relates to an improvement matching algorithm for analysing an X-ray images including an adaptive wavelet function as a linear combination of basic circular wavelet function which is an optimal wavelet function using dilations and shift of circular wavelets as building blocks. The resulting algorithm sequentially selects the most significant coefficient as one term on the linear combination that approximates the object. The matching results satisfy properties of rotation invariance, enabling match using only one angle view. The matched wavelet for other views can be quickly obtained by simply rotating the one matched result to the right angle.

### CROSS-REFERENCE TO RELATED APPLICATIONS

This patent claims the benefit of U.S. patent application Ser. No. 60/189,736, filed Mar. 16, 2000.

### FIELD OF THE INVENTION

This invention relates to computerized image processing, and more specifically to the matching of computerized images.

### BACKGROUND

Wavelet transforms of images provide a representation of space and frequency. Very often a particular frequency component occurring at any location in an image can be of particular interest. For example, frequency analysis can be used to provide edge detection (high frequency) as well as information about texture (apple vs. orange). In such cases it is beneficial to know the spatial intervals these particular spectral components occur. Wavelet transforms are capable of providing the space and frequency information simultaneously, hence giving a space-frequency representation of the signal.

Wavelet transforms use various high pass and low pass filters to filter out either high frequency or low frequency portions of the signal. For an image, the signal is a row or column of pixels. The transform of the image is the combined transform of the rows and columns. This procedure is repeated and each time some portion of the signal corresponding to some frequencies being removed from the signal.

For example, suppose a signal has frequencies up to 1000 Hz. In the first stage it is split into two parts by passing the signal through a high pass and a low pass filter which results in two different versions of the same signal: portion of the signal corresponding to 0-500 Hz (low pass portion), and 500-1000 Hz (high pass portion). The process is repeated on either portion (usually low pass portion) or both. This operation is called “decomposition.” Assuming that one uses the lowpass portion, the result is three sets of data, each corresponding to the same signal at frequencies 0-250 Hz, 250-500 Hz, 500-1000 Hz.

If one takes the lowpass portion again and passes it through low and high pass filters, the results are four sets of signals corresponding to 0-125 Hz, 125-250 Hz,250-500 Hz, and 500-1000 Hz. The process may continue like this until the signal is decomposed to a predefined certain level. That provides a collection of signals which represent the same signal, but all corresponding to different frequency bands.

Higher frequencies are better resolved in space and lower frequencies are better resolved in frequency. This means that, a certain high frequency component (edge detection) can be located better in space (with less relative error) than a low frequency component. On the contrary, a low frequency component (texture) can be located better in frequency than a high frequency component.

The term “wavelet” means a small wave. Its smallness refers to its (window) function that is of finite length. The wave refers to the condition that this function is oscillatory. The term “mother” implies that the functions with a different region of support that are used in the transformation process are derived from one main function, or the mother wavelet. In other words, the mother wavelet is a prototype for generating the other window functions.

The term “translation” is used in the sense that the window is shifted through the signal. This term, obviously, corresponds to spatial information in the transform domain. The parameter “scale” in the wavelet analysis is similar to the scale used in maps. As in the case of maps, high scales correspond to a non-detailed global view (of the signal), and low scales correspond to a detailed view. Similarly, in terms of frequency, low frequencies (high scales) correspond to a global information of a signal (that usually spans the entire signal), whereas high frequencies (low scales) correspond to a detailed information of a hidden pattern in the signal (that usually lasts a relatively short time).

Scaling, as a mathematical operation, either dilates or compresses a signal. Larger scales correspond to dilated (or stretched out) signals and small scales correspond to compressed signals. Fortunately in practical applications, low scales (high frequencies or edges on objects in an image) do not last for the entire area of an image.

The mother wavelet is chosen to serve as a prototype for all windows in the process. All the windows that are used are the dilated (or compressed) and shifted versions of the mother wavelet. There are a number of functions that are used for this purpose. The Morlet wavelet and the Mexican hat function are conventional mother wavelets.

Once the mother wavelet is chosen the computation starts with s=1 and the continuous wavelet transform is computed for all values of s, smaller and larger than “1”. However, depending on the image signal, a complete transform is usually not necessary. For all practical purposes, the image signals are bandlimited, and therefore, computation of the transform for a limited interval of scales is usually adequate.

For convenience, the procedure will be started from scale s=1 and will continue for the increasing values of s, i.e., the analysis will start from high frequencies and proceed towards low frequencies. This first value of s will correspond to the most compressed wavelet. As the value of s is increased, the wavelet will dilate. The wavelet is placed at the beginning of the signal at the point which corresponds to time=0. The wavelet function at scale “1” is multiplied by the signal and then integrated over all times. The result of the integration is then multiplied by the constant number 1/sqrt{s}. This multiplication is for energy normalization purposes so that the transformed signal will have the same energy at every scale. The final result is the value of the transformation, i.e., the value of the continuous wavelet transform at time zero and scale s=1. In other words, it is the value that corresponds to the point tau=0, s=1 in the time-scale plane.

The wavelet at scale s=1 is then shifted towards the right by tau amount to the location t=tau, and the above equation is computed to get the transform value at t=tau, s=1 in the time-frequency plane.

This procedure is repeated until the wavelet reaches the end of the signal. One row of pixels on the space-scale plane for the scale s=1 is now completed.

Then s is increased by a small value. This is a continuous transform, and therefore, both tau and s must be incremented continuously. However, if this transform needs to be computed by a computer, then both parameters are increased by a sufficiently small step size. This corresponds to sampling the time-scale plane. The above procedure is repeated for every value of s. Every computation for a given value of s fills the corresponding single row of the time-scale plane. When the process is completed for all desired values of s, the CWT of the signal has been calculated.

Lower scales (higher frequencies) have better scale resolution (narrower in scale, which means that it is less ambiguous what the exact value of the scale) which correspond to poorer frequency resolution. Similarly, higher scales have scale frequency resolution (wider support in scale, which means it is more ambitious what the exact value of the scale is), which correspond to better frequency resolution of lower frequencies. Computers are used to do most computations.

At higher scales (lower frequencies), the sampling rate can be decreased, according to Nyquist's rule. In other words, if the time-scale plane needs to be sampled with a sampling rate of N_{—}1 at scale s_{—}1, the same plane can be sampled with a sampling rate of N_{—}2, at scale s_{—}2, where, s_{—}1<s_{—}2 (corresponding to frequencies f1>f2) and N_{—}2<N_{—}1. In other words, at lower frequencies the sampling rate can be decreased which will save a considerable amount of computation time.

The one-dimensional wavelet transform above described is easily extended to the two-dimensional wavelet transform. The two-dimensional wavelet transform is useful for image analysis. Conventional 2-dimensional wavelet transforms apply a one-dimensional wavelet transform to each row of an image. Then the same transform is applied to each column. However, the one-dimensional wavelet transform is performed sequentially level by level.

A wavelet matching method fits a mother wavelet to a signal of interest, such that: (1) the wavelet generates an orthogonal multi-resolution analysis (MRA) and (2) the wavelet is as close as possible to the given signal in the sense of minimizing the mean squared errors between their squared amplitude spectra and their group delay spectra respectively. This generates a wavelet that is close to the given signal in shape. The application of such a wavelet would be in the optimal detection of the signal in the presence of signal dilations and noise. See J. O. Chiapa and M. R. Raghluveer (now known as R. M. Rao), “Optimal matched wavelet construction and its application to image pattern recognition,” Proc. SPIE Vol. 2491, Wavelet Application II, Harold H. Szu; Ed. April 1995.

### Approach to a Two-dimensional Wavelet Matching Solution

As expected, the approach of extending the matching method to the 2-D situation is not straightforward. The first one-dimensional sequence (or the horizontal sequence) is formed by taking the first (top) row of the image. Scanning along this top horizontal row of the image creates a one-dimensional sequence. That procedure is repeated for the next rows of the image to create a series of one-dimensional sequences. These one-dimensional sequences are then wavelet-transformed to compute the (horizontal) wavelet coefficients. The horizontal wavelet coefficients are placed back into two-dimensional images (sub-images). These images are then scanned to create the vertical sequences. These vertical sequences are then wavelet-transformed, and the resulting sequences are rearranged to the two-dimensional image format.

For more background, the reader is referred to THE ENGINEER'S ULTIMATE GUIDE TO WAVELET ANALYSIS: THE WAVELET TUTORIAL by Robi Pokikar at http://www.public.iastate.edu/˜rpolikar/WAVELETS/WTtutorial.html. Further background is found in U.S. Pat. No. 5,598,481 whose entire disclosure is incorporated by reference to that patent. Another approach is to attempt matching a separable 2-D wavelet to the object. But separable wavelets are not robust with respect to rotation. A wavelet matched to an object at one orientation will not work when the object is rotated because the correlation or convolution is carried out in Cartesian coordinates. Although the basic non-separable, circularly symmetric wavelet function works well in extracting, separating, and enhancing features of an image, most of the objects of interest do not necessarily have a circular shape or structure.

The main problem in two dimensions is the new degree of freedom related to orientation. A wavelet matched to an object at one orientation will not work when the object is rotated. Thus an isotropic wavelet is required.

### SUMMARY

The invention provides a two dimensional smooth circular symmetric wavelet that is rotatable. The wavelet is a modification of the Mexican hat wavelet. The wavelet is used in computer imaging systems and programs to process images. Reference images of a target, for example, x-ray images of an apple, are processed to provide one or more filter wavelets that are matched to the reference image(s). Each filter wavelet may be chosen for its desired characteristic. However, the wavelet that has the highest coefficient of convolution provides the most likely filter wavelet for use in detecting images of the object in target images. The target images may be photographs or x-ray images. The wavelet operates on the image to recognize portions of the image that correlate to the filter wavelet. As such, the target image may include a number of images of the target object and other objects.

The invention is implemented in a computer that matches a target image signal to one or more known or reference image signals. The computer has a processor and a main memory connected to the processor. The memory holds programs that the processor executes and stores data relevant to the operation of the computer and the computer programs. The computer has an output display subsystem connected to the processor and data entry subsystem connected to the processor. An input device such as a keyboard, mouse or scanner enters commands and data. A software program stored in the memory operates the computer to perform an number of steps for creating a matched wavelet of an object image and for processing a target image to detect the target object in the target image. The program begins by matching a plurality of two dimensional circular symmetric daughter wavelets to an original pixel image to produce a filter matched wavelet that operates on target images. The filter wavelet is applied to the target image to generate a number of scaled wavelets transforms of the target image. The program the constructs a lower-dimensional projection of the combined wavelet function with a maximized projection index and then finds a plurality of lower-dimensional projections of the combined wavelet function. The next step is comparing the lower-dimensional projections of the combined wavelet function to one or more lower-dimensional projections of combined wavelet functions for known images, to find one or more known images matching the original unknown image.

### DESCRIPTION OF DRAWINGS

FIG. 1 shows the circular wavelet at scales 0.5, 1 and 2.

FIGS. 2a-2d shows the Barbara photo (2a) and how stripes are extracted (2c-2d).

FIGS. 3a-3g compare edge extraction using a circular wavelet, a Haar wavelet, and a Daubechies 4 wavelet.

FIG. 4. illustrates a wavelet matching procedure.

FIG. 5. is a flowchart of a general algorithm for wavelet matching.

FIG. 6 is a flowchart for selecting coefficients.

FIG. 7 is a flowchart of a shrink-convolution-restore algorithm.

FIG. 8 is a flowchart of an estimation-maximization algorithm.

FIG. 9 is a set of illustrations regarding a pear image. Row 1 is the original image, the final approximation, the values of the coefficients as a function of the loops and the correlation of the approximation to the original image.; rows 2-4 illustrate coefficient selection through loops 1-12. Each circle represents a coefficient and its size represents its dilation.

FIG. 10 compares row 1 the matched results image results for scale, ½ dilation and scale 2 with row 2 of the original image, a ½ shrunk image and a 2× enlarged image.

FIG. 11 compares row 1 of the matched wavelet at 0, 30 and 60 degrees rotation with the actual image at 0, 30 and 60 degrees.

FIG. 12a shows an image of a spring.

FIG. 12b is an enlarge portion of FIG. 12a.

FIGS. 13a,b and 13c,d are pairs of sample images showing the wire touching the spring and not touching, respectively.

FIG. 14a is a matching wavelet filter for an apple.

FIG. 14b is an image of an apple filtered with the wavelet of FIG. 14a.

FIGS. 15a, b and 15c, d are, respectively, sets of cherry and its wavelet transform and a candy and its wavelet transform.

FIG. 16 is a 3-D representation of the projection of the images showing how one projection clusters images and a rotated projection does not cluster.

FIG. 17 is flowchart of the BCM neural network.

FIGS. 18a,b show the values of the neuron weights to determine convergence: left 18a converges and right 18b diverges.

FIGS. 19a,b shows how the neuron weights determine convergence: left 19a convergent and right 19b divergent.

FIG. 20 shows the angle between data vectors and the neuron vector to determine the convergence.

FIG. 21 a shows one neuron test results for a touching wire (21a) and for a gap between the wire and the spring (21b).

FIG. 22a shows images of cherries and hard candies.

FIG. 22b shows the training results: dotted lines are cherries; plain lines are candies.

### DETAILED DESCRIPTION OF INVENTION

The fact that an isotropic wavelet is required implies that a circularly symmetric wavelet has to be employed. Therefore, the invention's approach is based on the circular wavelet and reflects the features of the object of interest, that is, it extracts portions of the pattern using the circular symmetric wavelet and combines the portions to form the desired matching wavelet function.

### Smooth Circularly Symmetric Two-Dimensional Wavelet Functions

The invention incorporates a 2-D filter which can pick up features uniformly along all directions, that is, a rotation of a 1-D function with the form of F(r, 8)=f(r), where f is a properly selected 1-dimensional function.

This 2-D circular symmetric wavelet function is defined as:

$${h}_{a} ( x , y ) = \frac{1 - ( {x}^{2} + {y}^{2} ) / 100 {a}^{2}}{5 \sqrt{π} \cdot a} {e}^{- ( {x}^{2} + {y}^{2} ) / 100 {a}^{2}}$$

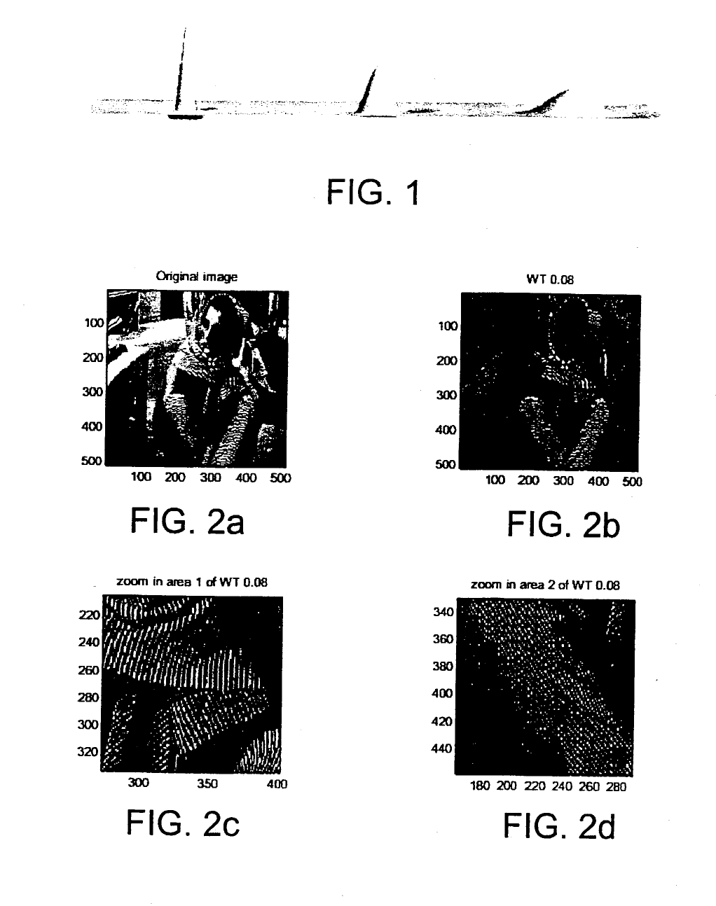

which is generated by rotating a 1-D function, modified from the double derivative of the famous Gaussian probability density function (a is the scale factor). Shapes of this wavelet at three different dilations (scales equal 0.5, 1, and 2, respectively) are as shown in FIG. 1. This is a modification of the well-known Mexican Hat wavelet.

### Features of the 2-D Circular Wavelet

To illustrate the orientation-invariance of circular wavelets, consider the image Barbara in FIG. 2. In this original image, similar textures appear in different orientations: stripes on the trousers, stripes on the headdress, grids on the tablecloth, grids on the chair. The circular wavelet with a=0.08 is able to extract them with high accuracy, and equally among all directions. In FIG. 2, the upper left picture shows the original image, the upper right the result after applying the circular wavelet, lower left and right are 2 enlargements of the wavelet result that show how well the stripes are extracted.

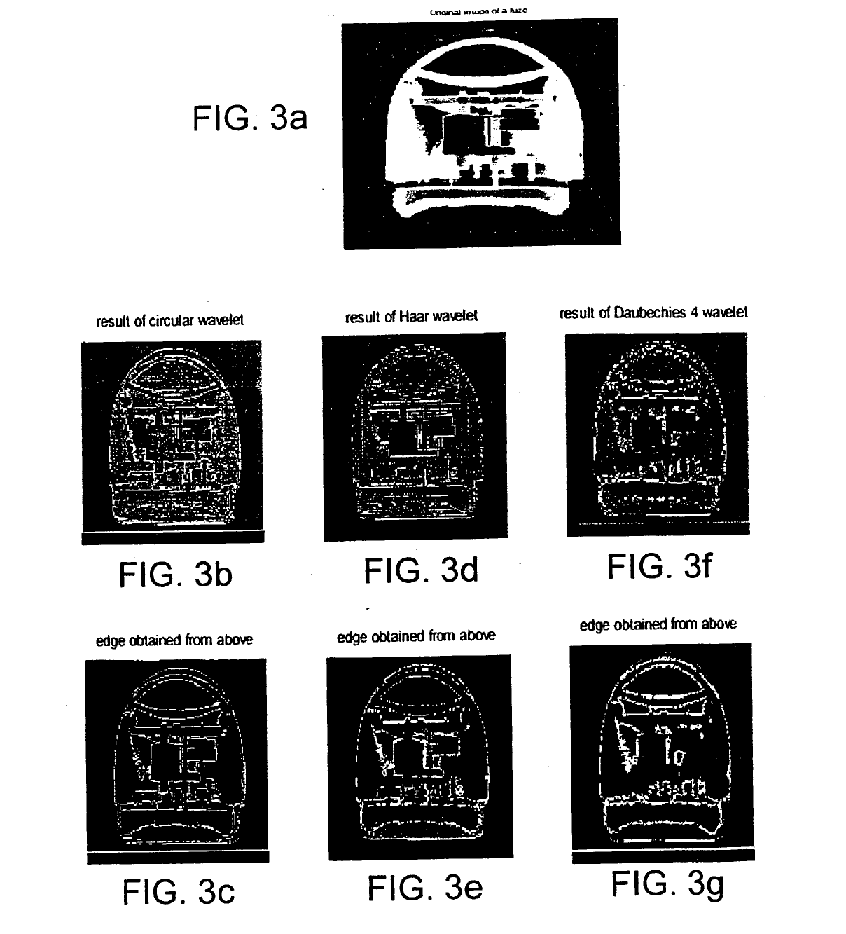

FIG. 3a shows the original x-ray image of the M549 Fuze. FIG. 3b shows the comparison of the results using the circular and two separable wavelet methods respectively. The first column shows the results for the circular wavelet, the second column is for the Haar Wavelet, and the third column is for the Daubechies 4 wavelet. The results in the second row are the edges of the object obtained from thresholding the images above them. It is evident that the circular wavelet can extract the edge and shape feature from the image better-more complete curve lines, smoother edges, and more precise details.

However, the circular wavelet concept alone is not enough to work as a matching wavelet method. The object to be detected does not necessarily have a circular contour. The invention builds up a matching wavelet on the circular wavelet as described in the next section.

### The 2-D Wavelet Matching Concept

A linear combination of wavelets is also a wavelet. The invention uses a smooth, circularly symmetric, 2-D wavelet for each object as its basic building block. The invention builds the adaptive wavelet function as a best-fitting linear combination using dilations and shifts of these basic circular wavelet functions, producing an optimal wavelet function. The algorithm is designed to recursively select the most significant coefficients as terms in the linear combination to approximate the object. This approach yields a wavelet which allows object detection at different orientations.

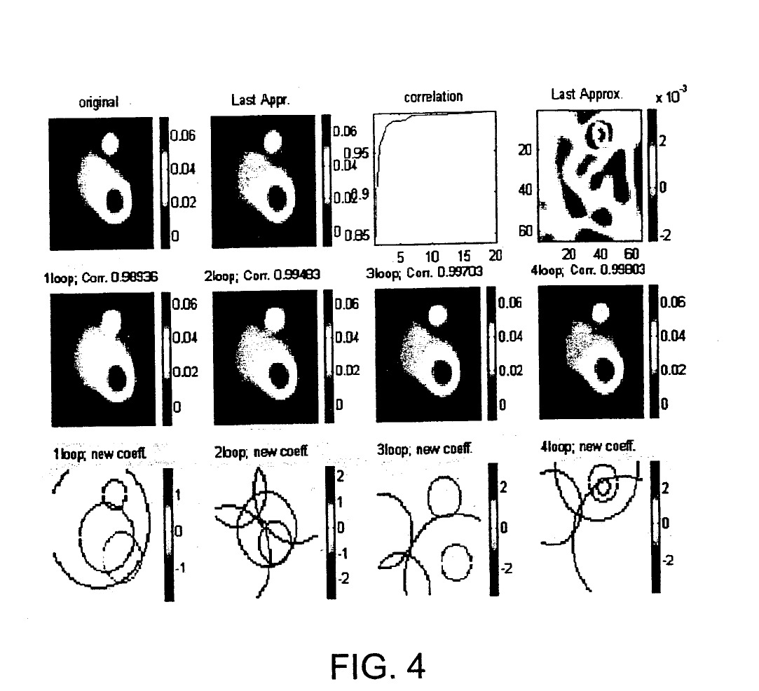

A simple sample illustrates this concept. In FIG. 4 the four images in row one show: (1) the sample image (original), (2) the final approximation after 20 loops, (3) the plot of correlation of every approximation with the original image to show the process of convergence, and (4) the final remainder after 20 coefficients have been extracted. The next two rows show the results of the process of each loop and the individual coefficients selected in each loop. Images in the second row are the results of approximations when selecting the first 5,10,15, and 20 coefficients, respectively; images in the third row are the coefficient map of the current 5 selections during that loop. A circle represents a coefficient with the disk indicating the non-zero area of the daughter wavelet, and the color of the circle indicates the value.

### The Matching Algorithm

### General Algorithm for Selecting Coefficients

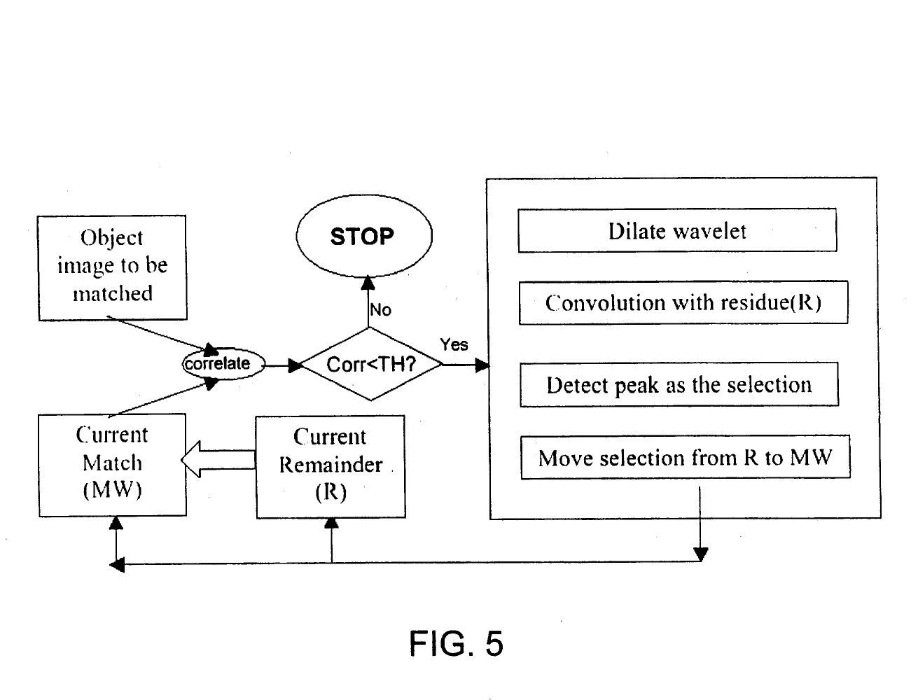

This algorithm recursively detects the most significant coefficient and takes a multiple of a daughter wavelet out of the image. The weighted summation of the daughter wavelets serves as an approximation of the original image. The main steps are shown in the graph of FIG. 5.

Mathematically, this method is expressed more precisely as follows: Suppose φ is the mother wavelet and I is the input image. Then the CWT of I with respect to φ is:

W(a,b₁,b₂)=<I(t₁,t₂),φ_{a,0,0}(t₁−b₁,t₂−b₂)>

where < > is the notation of dot product and

$${ϕ}_{a , {b}_{1} , {b}_{2}} ( {t}_{1} , {t}_{2} ) = \frac{1}{\sqrt{\vert a \vert}} ϕ ( \frac{{t}_{1} - {b}_{1}}{a} - \frac{{t}_{2} - {b}_{2}}{a} )$$

is the daughter wavelet at dilation a and shift (b₁, b₂).

What follows will compute a sequence of remainder functions {fₙ} to estimate new coefficients and build up the matching wavelet. Initially assign f₀: f₀(t₁,t₂)=I(t₁,t₂), for (t₁,t₂)εdomain (I). Assume that the (n−1)-th remainder fₙ₋₁ has been obtained and compute the fₙ as follows:

Mₙ=max a,b₁,b₂{<fₙ₋₁(t₁,t₂),φ_{a,0,0}(t₁b₁,t₂−b₂)>},

Now suppose ã, \tilde{b}₁, \tilde{b}₂ are the scale and shift values such that

Mₙ=W(ã,\tilde{b}₁,\tilde{b}₂),

and then the n-th remainder is

fₙ(t₁,t₂)=fₙ₋₁(t₁,t₂)−Mₙ·φ_{ã,0,0}(t₁−\tilde{b}₁,t₂−\tilde{b}₂).

The final approximation after N steps will be

$$\begin{matrix}{APP}_{n} ( {t}_{1} , {t}_{2} ) = {\sum }_{n = 1}^{N} {M}_{n} \cdot {ϕ}_{{\tilde{a}}_{n} , 0 , 0} ( {t}_{1} - {\tilde{b}}_{1 , n} , {t}_{2} - {\tilde{b}}_{2 , n} ) \\ = {\sum }_{n = 1}^{N} ( {f}_{n - 1} - {f}_{n} ) \\ = {f}_{0} - {f}_{N}\end{matrix}$$

and is the adapted wavelet function matching the image I.

### Implementation of the General Algorithm

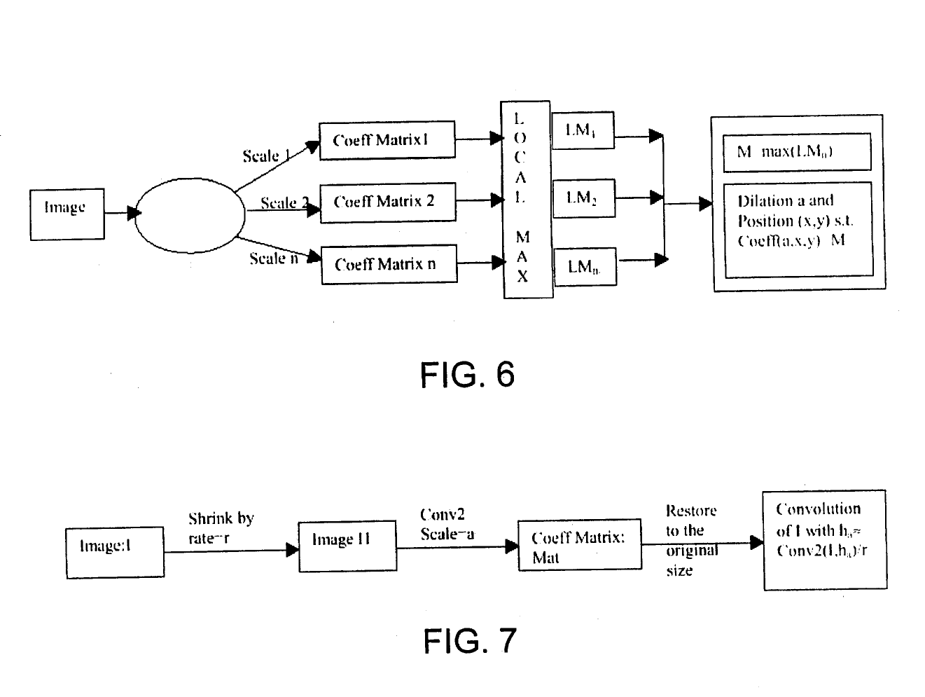

The central aim of each loop is to find the maximum coefficient and its location. The flowchart of FIG. 6 shows the steps in finding the maximum coefficient M and the coordinates (x, y) where the value M is taken. However, the basic approach to calculating the 2D wavelet function and performing the wavelet transform requires substantial computing time and computer memory. It was desired to have one or more methods for reducing the time and computing capacity for a wavelet transform without substantially sacrificing accuracy. The invention provides several methods for quickly calculating the maximum coefficient M.

The invention's implementation of this algorithm uses three techniques to facilitate obtaining a match with acceptable speed and accuracy. Specifically, the “SCR (Shrink-Convolution-Restore) method” speeds up the computation, the “Estimation-Maximization-Computation method” provides accuracy, and the “Complete Subtraction of Background method” permits the matching of textures. The resulting algorithms analyze the various types of images of interest and the behavior under rotation. They may be combined into a single efficient algorithm.

### SCR (Shrink-Convolution-Restore) Method

Lack of speed is a salient factor preventing most image-matching algorithms from being practical To choose each coefficient, the convolutions must be computed at all scales. The problem is that at each scale the computation task is the same as a complete process with the basic wavelet transformation alone. Furthermore, the time to find this one set of multiple convolutions is only a single step in choosing one coefficient. That is to say, if the average computation time for one convolution is A, then our new task will need at least the time A·S·L, where S is the range of the scale values and Lis the number of coefficients to be collected. Since the average computation time increases for coefficients with larger scale values, A must be reduced.

The invention's algorithm represented in FIG. 7 and described below mitigates this problem. The invention's method is based on the following mathematical computation. From the original definition

$${h}_{a} ( r , θ ) = \frac{1 - \frac{{r}^{2}}{100 {a}^{2}}}{5 \sqrt{π} a} {e}^{- \frac{{r}^{2}}{100 {a}^{2}}} .$$

It is easy to check that h satisfies the following equation by computing the h function values at scale k·a,

$${h}_{k \cdot a} ( r , θ ) = \frac{1}{k} {h}_{a} ( \frac{r}{k} , θ )$$

Therefore, for the convolution, we have:

$$\begin{matrix}c o n v 2 [ f ( r , θ ) , {h}_{k \cdot a} ( r , θ ) ] = \int \int f ( r , θ ) \cdot \frac{1}{k} {h}_{a} ( \frac{r}{k} , θ ) \cdot r \cdot ⅆ r \cdot ⅆ θ = \\ = \int \int f ( k \cdot s , θ ) \cdot \frac{1}{k} {h}_{a} ( s , θ ) \cdot ( k \cdot s ) \cdot ⅆ ( k \cdot s ) \cdot ⅆ θ ( use s = \frac{r}{k} ) \\ = k \int \int f ( k \cdot s , θ ) \cdot {h}_{a} ( s , θ ) \cdot s \cdot ⅆ s \cdot ⅆ θ \\ = k \cdot conv 2 [ f ( k \cdot s , θ ) , {h}_{a} ( s , θ ) ]\end{matrix}$$

This proves the following formula about the relation between the dilation of image and the dilation of the wavelet:

conv2[f(r,θ),h_{k·a}(r,θ)]=k·conv2[f(k·r,θ),hₐ(r,θ)].

Intuitively, it says that a factor can be moved from the subscript of h to the first argument of f by multiplying the result by that factor. This formula makes it possible to compute a convolution of a large scale ka by instead computing another convolution of a smaller scale a.

### The Estimation-Maximization-Computation Method

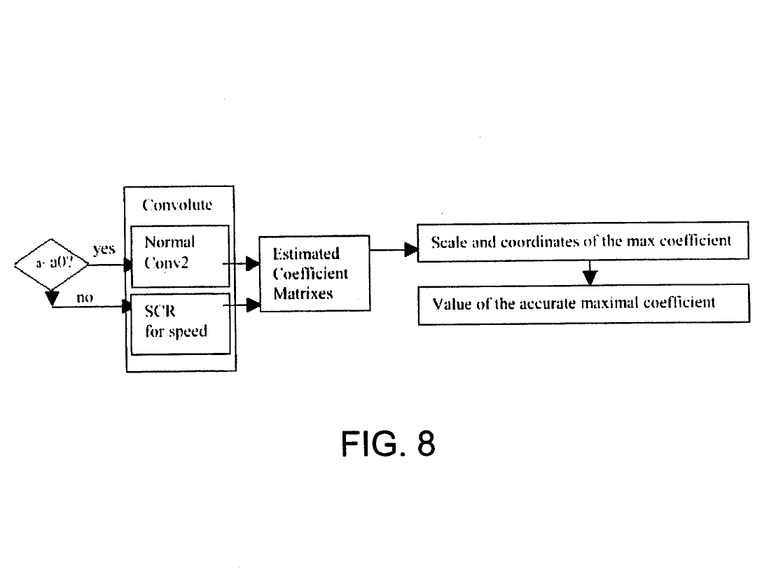

The algorithm described above (SCR -Shrink-Convolution-Restore) is fast but not accurate in some situations. This is especially true when k is large which makes the shrunk image distorted. The algorithm shown in FIG. 8 achieves both speed and accuracy as follows:

1) Use SCR for estimation of the coefficient matrixes at all scales;

2) Find the scale value and its shift position of the maximum coefficient; (note that the maximum value is discarded after selecting it);

3) Then use CONVONE as shown in FIG. 8 to compute the accurate value of the inner product. This may not be the real maximum value but it is considered sufficiently close for the current stage of processing. The real maximum coefficient will be selected in a later stage. The inner product computed is only one value, instead all the values in the whole matrix. This process requires only a tiny portion of the time A of computing a single convolution: A divided by the size of the image.

### The Complete Subtraction Method

The invention addresses the following problem: when the selection reaches the edge of the image I, the convolution of the remainder might not be zero at the position of the coefficient just subtracted. This might cause the selection to become stuck at a certain position, or an inaccurate coefficient to be calculated.

Mathematical analysis of the problem:

a) Normally, if v₁∘v₂=m and v₁∘v₂=1, then,

(v₁−m·v₂)∘v₂=m−m=0.

b) In the step of computing the wavelet at each scale, the wavelet coefficient at position (x,y), COEF(I, W, x, y)=J(x, y), where J(x, y) is computed as the dot product of Ĩ with \tilde{W} (the part of I and W intercepting at the shift position (x,y)). Since \tilde{W}, is not the whole W, the norm of it might not be 1. Suppose that Ĩ∘\tilde{W}=m and \tilde{W}∘\tilde{W}=p, where p does not equal 1, so

(Ĩ−\tilde{m}·\tilde{W})∘\tilde{W}=Ĩ∘\tilde{W}−m·(\tilde{W}∘\tilde{W})=m−m·p≠0

c) The invention solves this problem as follows:

Define a new number

$$\tilde{m} = \frac{m}{p} ,$$

as the modified coefficient at (x, y), which will make the difference to be 0. Then

$$\begin{matrix}( \tilde{I} - \tilde{m} \cdot \tilde{W} ) ∘ \tilde{W} = \tilde{I} ∘ \tilde{W} - \tilde{m} \cdot ( \tilde{W} ∘ \tilde{W} ) \\ = m - \frac{m}{p} \cdot p \\ = 0\end{matrix}$$

This modification is compatible with the regular case: where \tilde{W}∘\tilde{W}=1.

This will force each selection to be totally subtracted, solving the problem.

### Features of The Matching Wavelet

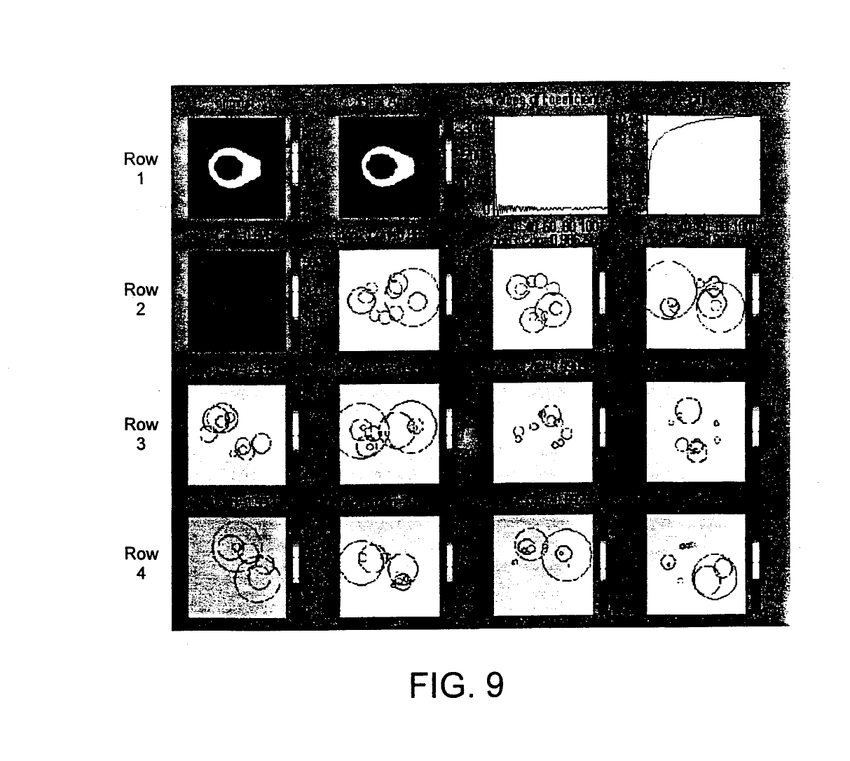

The invention's matching wavelet possesses two important special properties: its behavior under dilation and rotation. These properties make the matching method more useful and efficient in the optimal detection of a signal when in the presence of signal dilations and noise. First see FIG. 9, which shows a sample result of matching an object (a “pear”).

### Behavior Under Dilation

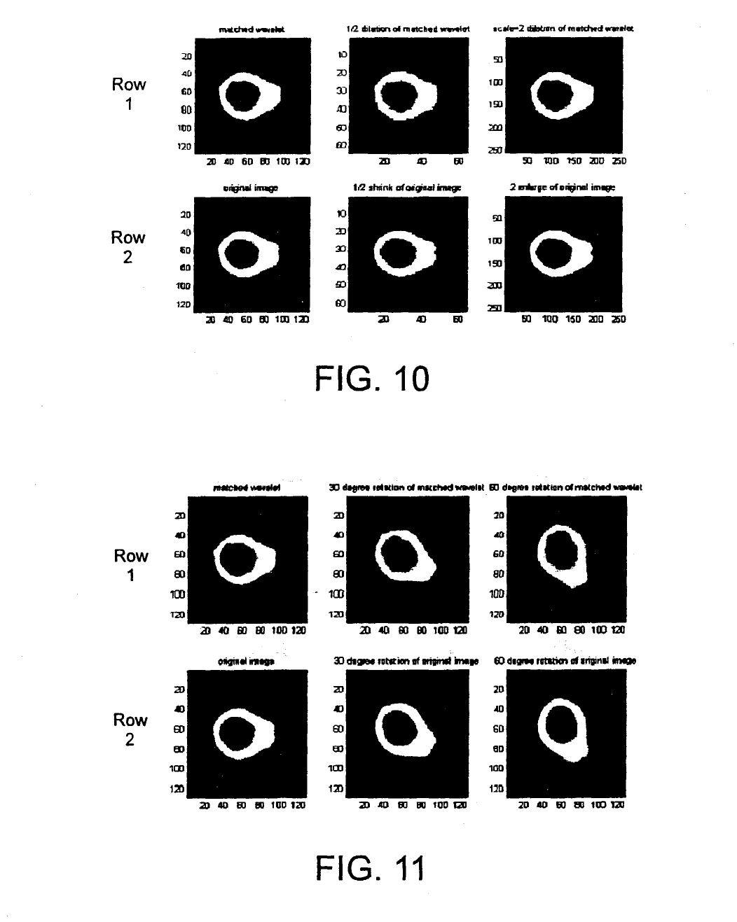

The result of matching is a sequence of coefficients, including the coordinates, the values, and their dilations. Once this information is calculated, the pattern image is expressed as the sum of circular wavelet units. The invention varies the matched result by simply making changes to the coefficients. One such change is dilation. FIG. 10 shows the above matching result being dilated in 2 scales, and the enlarged (shrunk) images are placed below each dilation for comparison.

### Behavior Under Rotation

The result of matching has the property of rotation invariance which makes it possible that only one angular position per object is needed to be calculated through the matching process, and the matched wavelet at other angles can be quickly obtained by simply rotating the one matched result to the right angle. FIG. 11 shows the procedure of matching the pear at varying rotation angles.

### Applications

The invention's matching algorithm has been applied to many different images to extract features about edge, shape, and texture: x-ray images of fruit, luggage, mechanical parts, and CT slices, as well as samples of ultrasonic images and thermal images.

### Edge Analysis

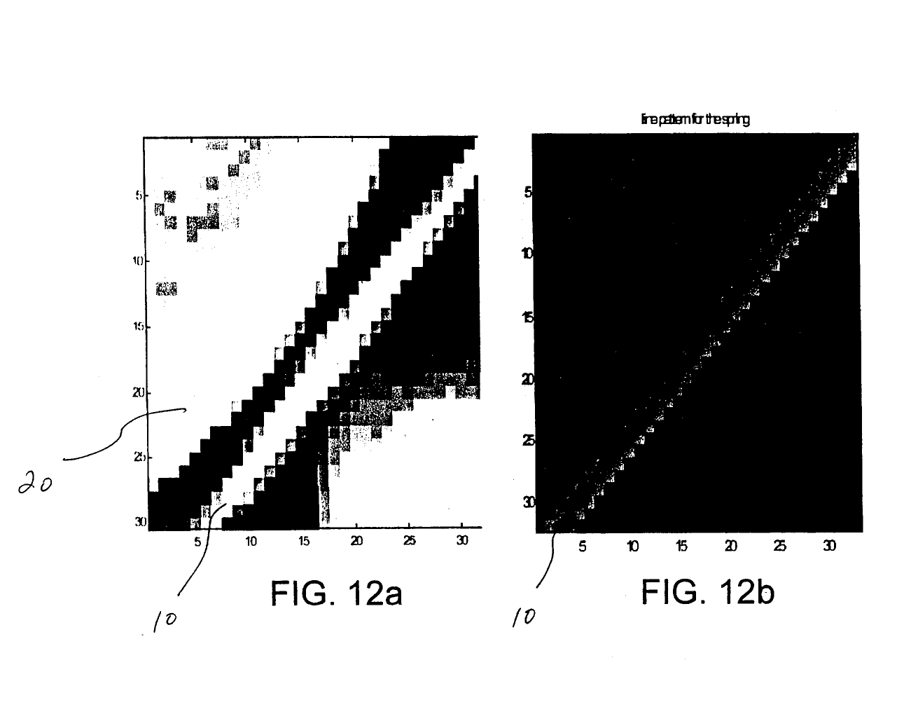

As one example of using matching wavelet in edge analysis, FIG. 12 shows part of a mechanical fuse, with a spring cut out as the pattern to be matched. The matching result was then applied to sample images to detect the possible defects caused by improper positioning of the spring.

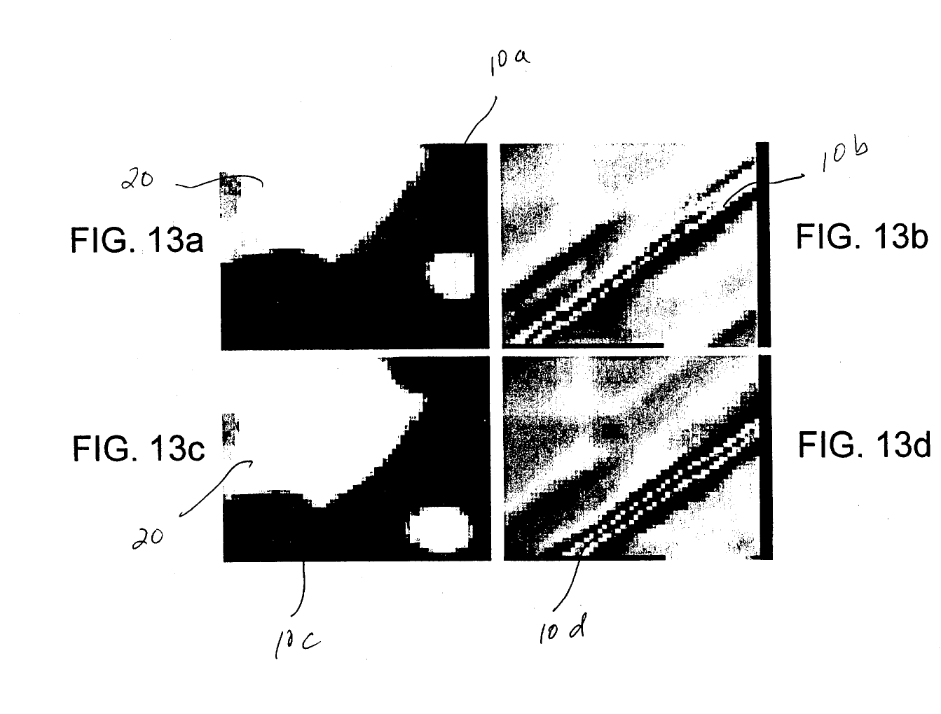

FIGS. 13a-d show two sample images and the results after applying the above matching filter. The relative position of the spring 10 with respect to the block 20 (from the figures on the left) can be detected by analyzing the values along the lines 10a-10d in the figures on the right, which are the results of applying the matching result of FIG. 12.

Note that the image in row one-left has the spring touching the block closely and corresponds to the transform result at right having less blue line above the red line. For the example in row two, the spring doesn't touch the block and correspondently its transformation has one solid blue line above the red line.

### Texture Analysis

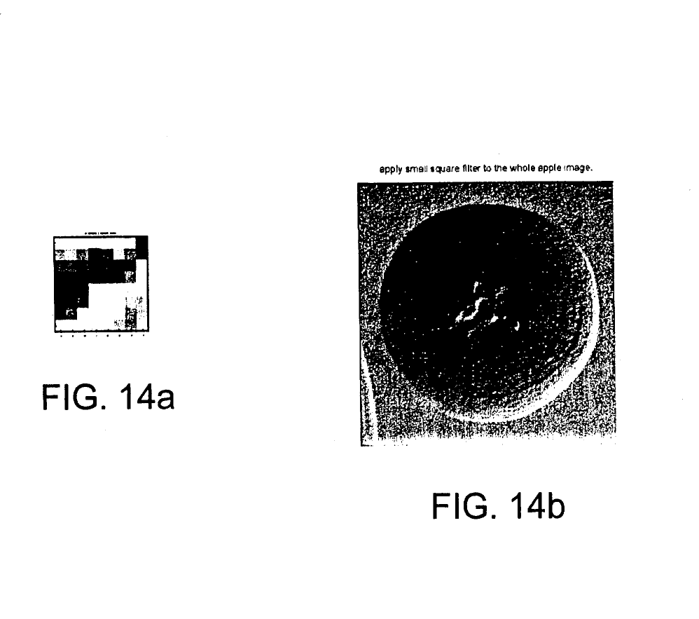

If a part of the image being matched includes a certain pattern of texture, we can arrange the matching process to let the result match the texture. We then use the result as a filter to extract information on similar pattern of texture in other images. FIG. 14 shows one filter created using the matching wavelet method for an apple image and the result of applying that filter to the entire image of the apple. The filter was calculated using a small patch on the pulpy area of the apple.

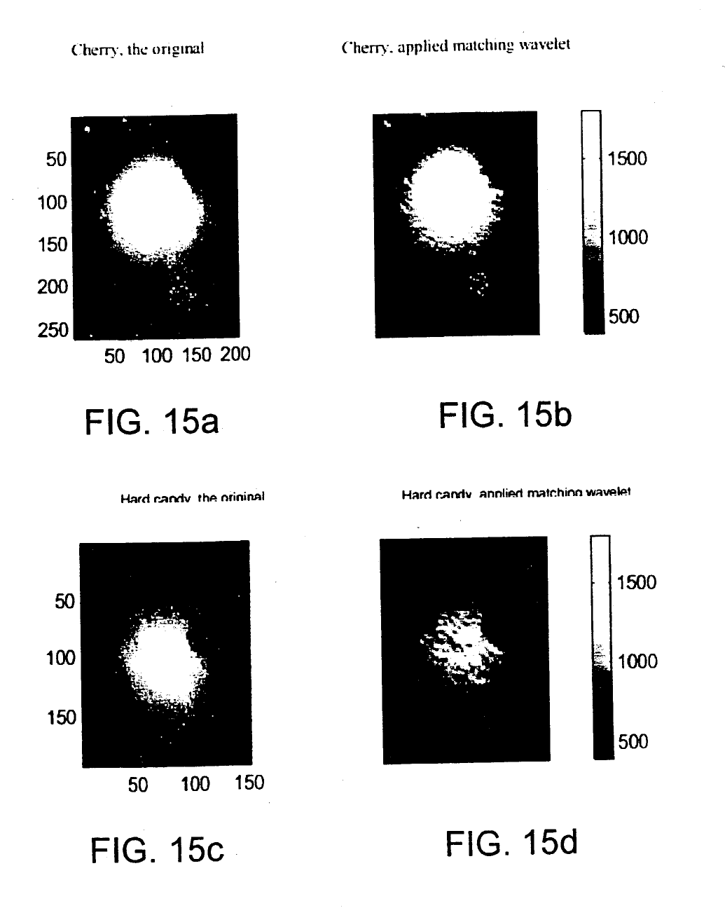

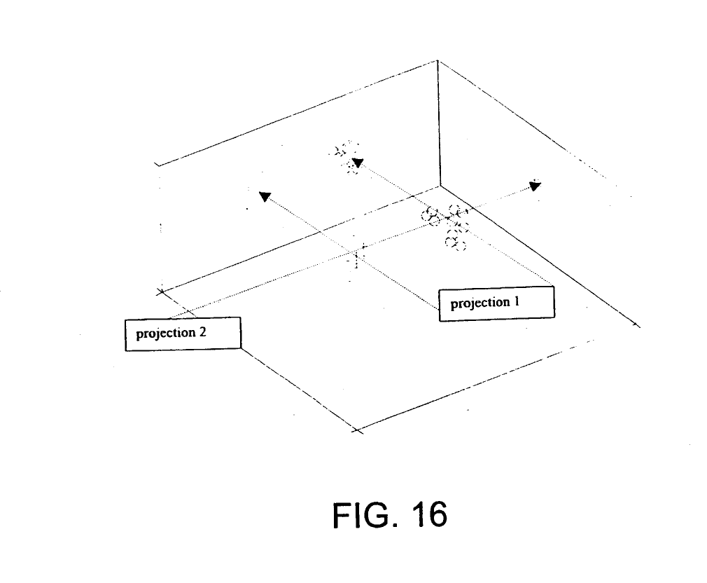

The same technique was used on different fruits/objects to extract different features that distinguish them. FIG. 15 shows original images of a cherry (upper row) and a piece of candy (lower row) and demonstrate the use of the method to distinguish between the two by applying a matching wavelet for texture pattern recognition.

### Unsupervised Feature Extraction Network and Clustering Tool

### Background

Although matching wavelet and other techniques can enhance and reveal various features such as edges and textures, it is not feasible to directly apply these results into a classifier or make judgement because of their high dimensionality. The curse of dimensionality says that it is impossible to base the recognition on the high-dimensional vectors directly, because the number of training patterns needed for training such a classifier should increase in an exponential order with the dimensionality. Mathematically speaking, feature extraction can be viewed as such a dimensionality reduction from the original high-dimensional vector space to a lower dimensional vector space that enough information that discriminates the different classes is kept. That is, if the important structure (for classification) can be represented in a low-dimensional space, dimensionality reduction should take place before attempting the classification.

Furthermore, due to the large number of parameters involved, a feature extraction method that uses the class labels of the data may miss important structure that is not exhibited in the class labels, and therefore be more biased to the training data than a feature extractor that relies on the high-dimensional structure. This suggests that an unsupervised feature extraction method may have better generalization properties in high-dimensional problems.

Many feature extraction theories for object recognition are based on the assumption that objects are represented by clusters of points in a high dimensional feature space. Projection pursuit is to pick interesting low-dimensional projections of a high-dimensional point cloud by maximizing an objective function called the projection index. As a simple explanation, the next picture shows when a good direction is selected, one projection can reveal better cluster information than that of a bad one.

The Bienenstock, Cooper and Munro (BCM) neuron performs exploratory projection pursuit using a projection index that measures multi-modality. Sets of these neurons are organized in a lateral inhibition architecture which forces different neurons in the network to find different projections (i.e., features). A network implementation, which can find several projections in parallel while retaining its computational efficiency, can be used for extracting features from very high dimensional vector space. The invention includes an Unsupervised Feature Extraction Network (UFENET) based on the BCM Neuron. Bienenstock, E. L., Cooper, L. N., and Munro, P. W. (1982). Theory for the development of neuron selectivity: orientation specificity and binocular interaction in visual cortex. Journal Neuroscience, 2:32-48

### Build Ufenet

The BCM neurons are constructed such that their properties are determined by a nonlinear function θₘ which is called the modification threshold. The activity of neuron k is given by cₖ=mₖd, where mₖ is the synaptic weight vector of neuron k, and d is the input vector. The inhibited activity of neuron k is defined as

$$\overline{{c}_{k}} = σ ( {c}_{k} - η {\sum }_{j \neq k} {c}_{j} ) ,$$

and the modification threshold is

$$\overline{{θ}_{m}} = E [ \overline{{c}_{k}^{2}} ] ,$$

where a is a monotone saturating function—a smooth sigmoidal function. The synaptic modification equations are given by

$${\dot{m}}_{k} = μ [ φ ( \overline{{c}_{k}} , \overline{{θ}_{m}^{k}} ) {σ}^{′} ( \overline{{c}_{k}} ) - η {\sum }_{j \neq k}^{} φ ( \overline{{c}_{j}} , \overline{{θ}_{m}^{j}} ) {σ}^{′} ( \overline{{c}_{j}} ) ] d$$

where σ′ represents the derivative of the function σ, and μ is the learning rate.

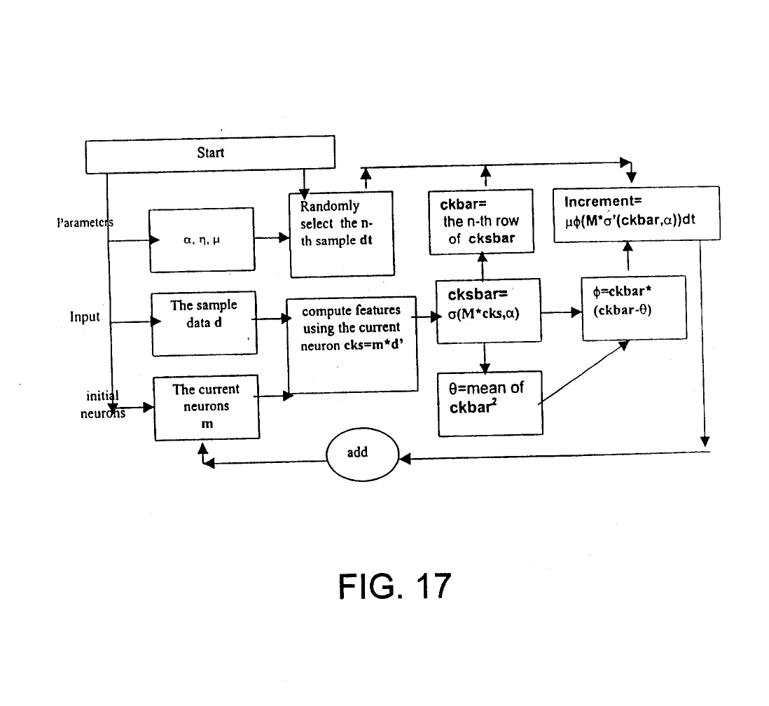

FIG. 17 presents the flowchart for the UFENET adaptation algorithm. In the flowchart:

M=I−η(E−1)

where I is the unit matrix and E is the matrix with every element as 1,

$$σ ( x ) = \frac{1}{1 + {ⅇ}^{- ax}} ,$$

and σ′(x) is the derivative of σ(x).

### Determining the Stopping Point of UFENET

In order to configure UFENET and to terminate it properly, the invention uses the following method to judge the status of a BCM network.

1. Check the convergence of the iterations:

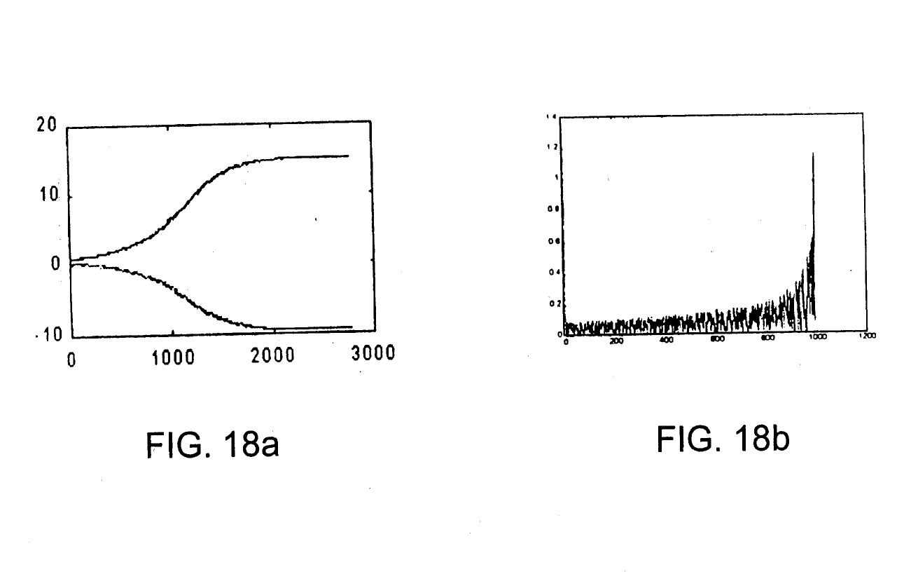

a) check the tendency of the iterations by plotting some neuron coordinates (FIG. 18).

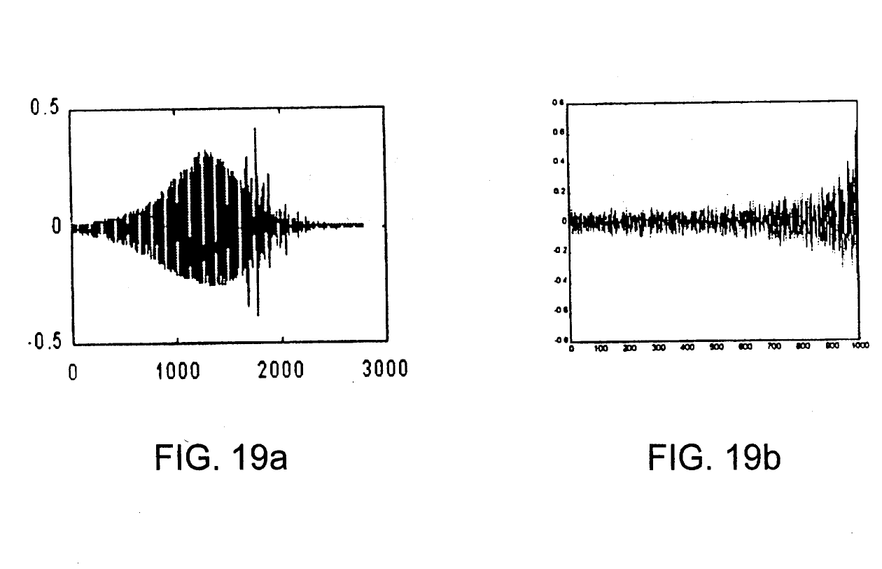

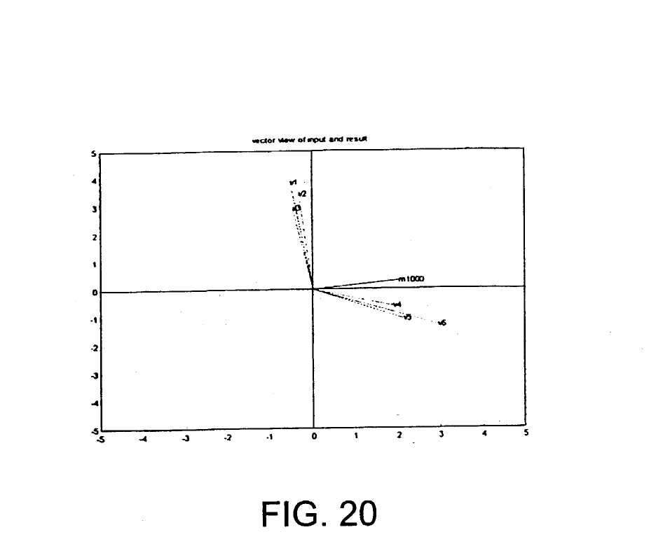

b) check the increment of the neuron coordinates (FIG. 19).

c) check the angles(generalize in hyperspace] between the neuron and the sample vectors: If the computation is converged, the resulting neuron vector, should be perpendicular (or as perpendicular as possible) to all but one cluster of the samples in the space.

2. Observe the clustering situation of the resulting feature distribution

The invention's goal here is only to find a set of good features such that the critical information for discriminating among different clusters is kept. Therefore, for the consideration of efficiency, precise convergence of the network is not really necessary. Therefore, a looser standard to judge the network results is used to observe the clustering of the resulting features extracted by using the neurons obtained.

3. Judge the performance of the network by the final classification results. Because the ultimate goal here is to obtain accurate classification results, the eventual judgment of the result should be the final classification result. It is suggested that a test classification can be performed to judge the convergence.

### Single Neuron Network

The single neuron network is used in two ways: it is simple, making it usable in analyzing and adjusting the network, and it has a single output when applied to the data, allowing its use as a simple classifier.

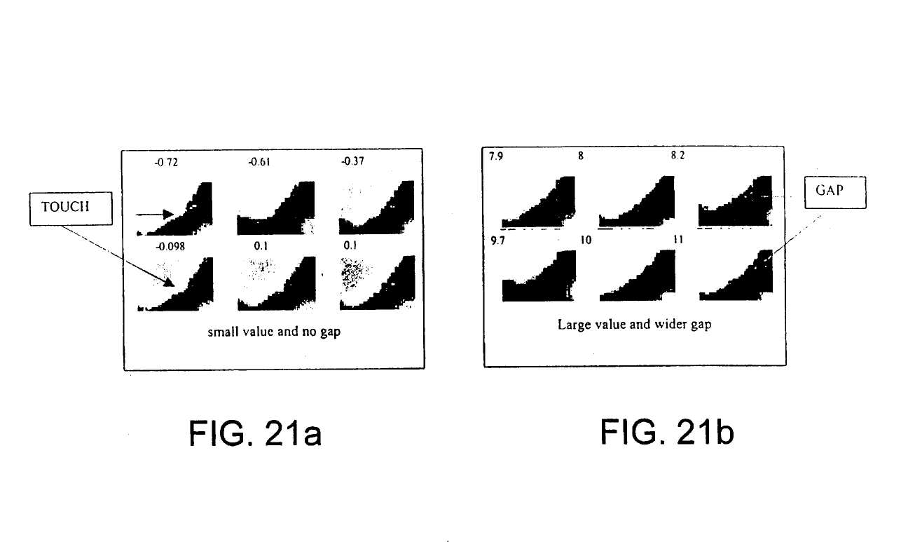

A simple test using the neuron vector resulting from the previous training showed the following: the inner product of 12 testing samples (other than the 5 training samples) was calculated with the neuron. The larger values correlated to those samples with the wider gap as shown in FIG. 21b.

The 6 pictures in FIG. 21 a have small inner products (−0.72-0.14), corresponding to the six images with no gap (i.e., touching), while the 6 in FIG. 21b have large inner products (7.9-11.0) corresponding to the other six images with wider gap (i.e., not touching).

### Multiple Neuron UFENET

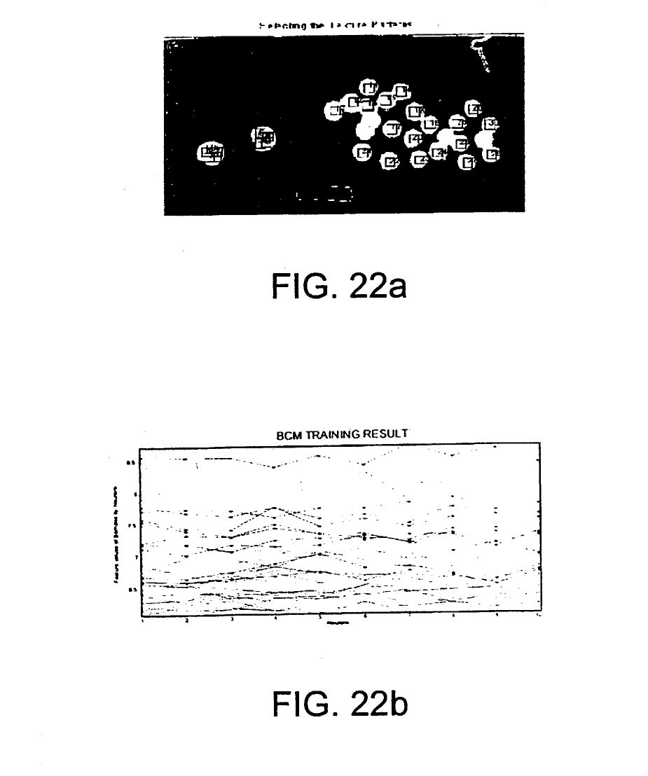

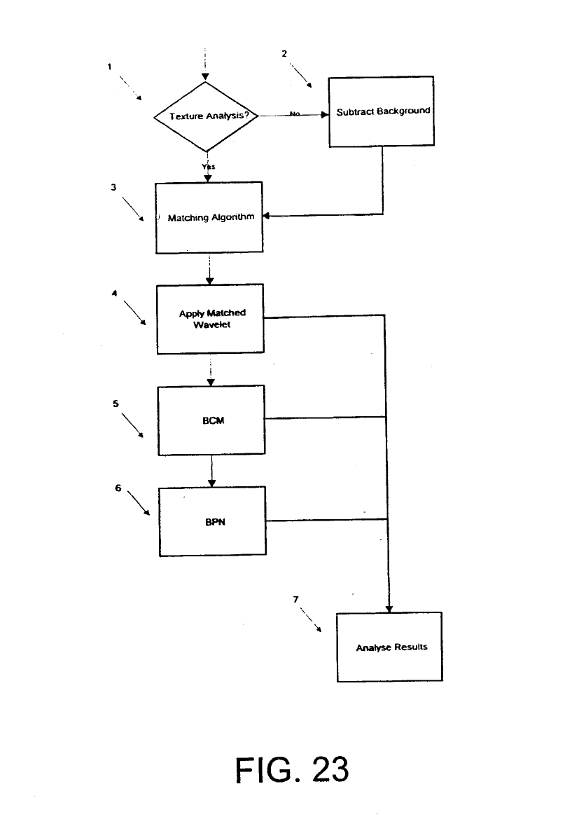

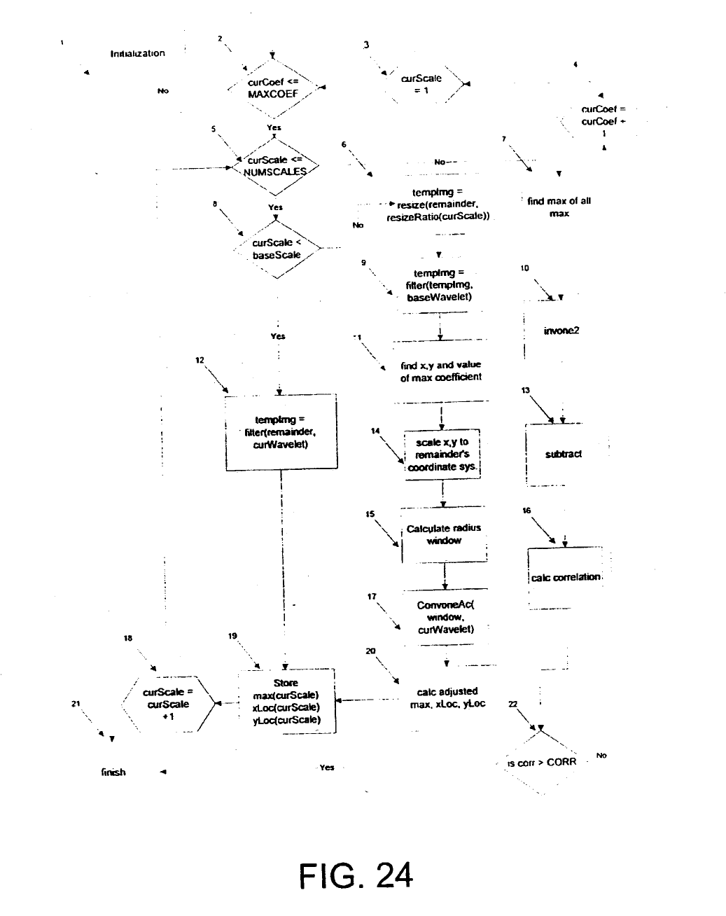

With reference to FIGS. 22a,b, samples of cherries and hard candy have a matching wavelet applied and the results are sent to the network. FIG. 22b shows that the cherry feature vectors (represented by the dotted lines) and the candy features (represented by the plain lines) are separated (almost) after training.

### Operation of The Invention

The invention is most useful in doing a variety of different types of image analysis. The matched wavelet of a sample can be applied to a given image and the locations of high similarity (a good match) will show strong distinguishable peaks. The invention can thus examine images individually and manually, or it can automate the analysis of images through the use of the UFENET and possibly a back-propagation network. The analysis can be done in a spatial context or in a textural context. See FIG. 23.

In examining individual images, the invention creates a matched wavelet of a shape, object or arrangement of objects being examined. The invention then applies this filter to samples that may or may not contain the desired shape. The filter returns a strong signal on samples that match well. By feeding a number of these samples to the UFENET, the invention reduces the dimensionality of the output to allow better examination of the data. The invention may then pass this data to a back-propagation network if fully automatic grouping is desired. This allows each sample processed to be labeled as group A/group B or good/bad etc.

Processing the texture of samples is another application. Often the differences between a “good” sample and a “bad” sample are hidden in the texture. In this case the invention subtracts the background from each of the samples (FIG. 23, Reference 2) in order to isolate the background. The invention then proceeds in a manner similar to object detection, except that it may use only a piece of the matched wavelet as its filter. This helps keep the processing localized, as is desired in texture analysis. Again, the invention can use the UFENET and possibly the back-propagation network to better analyze the results.

### Collecting and Pre-processing the Data Samples

In order to use the matching procedure to differentiate two classes of images the invention first selects a number of samples of each class of image, e.g., in comparing samples of apple textures vs. samples of orange textures, the invention uses a representative number of small images of each. In order to isolate the texture, some preprocessing is done such as subtracting the local mean or median from the samples.

### Wavelet Matching

The invention creates a matched wavelet of one of the classes to be differentiated by applying the matching algorithm (described below) on a sample. The matched wavelet returned by the matching procedure can be applied as a whole, or as is the case with texture, it is sometimes helpful to use only a small piece of the matched wavelet as the filter.

See FIG. 24. The basic flow of the matching procedure is to apply a number of different-scale circular wavelets to the input image (using convolution) on each pass of the main loop and to choose the one coefficient from the pool of all the transforms that has the greatest absolute value. The location and value of this coefficient is determined and stored along with the scale of the wavelet that produced it. Next a circular wavelet equal to the determined value multiplied by a circular wavelet (of the stored scale) is subtracted from the original image and added to an accumulator image (the matched wavelet). The next time through the loop the process is repeated using the remainder of the previous loop. This process continues until one of two conditions is met: the maximum number of coefficients is reached or the correlation between the original image and the matched wavelet is above a desired level.

If the scales in use get too large, the convolution on each pass may take too long. So when the scale of the wavelet goes above some threshold (baseScale) the invention shrinks the image, applies a smaller wavelet, gets an approximate maximum, then after choosing which scale will give the maximum, performs the proper convolution in the desired location only (convoneAc). This method speeds up the process greatly and produces results very similar to those achieved without using the shrink method.

Matching Algorithm Step by Step

See FIG. 24.

Input Parameters:

Original—the image to match. It is assumed in this implementation that the image inputted to the algorithm is pre-padded with r pixels of real image data on all four sides where r is equal to the radius of a wavelet of MAXSCALE

MINSCALE—the smallest wavelet scale to use

STEP—the step amount between wavelet scales to use

MAXSCALE—the largest wavelet scale to use

MAXCOEF—the maximum number of coefficients to calculate

MINCORR—the minimum correlation required to quit before MAXCOEF is reached

Output:

Mwavelet—the matched wavelet calculated

Step 1 (FIG. 24 Reference 1): General Initialization

Step 2 (FIG. 24 Reference 2): Main Loop

We will loop until the desired number of coefficients have been determined or until the desired correlation between the matched wavelet and the image to be matched has been reached. At the end of each loop we will have found the location, value and wavelet scale of the single coefficient we have determined to be the most dominant. We will then subtract a multiple of the circular wavelet of this scale, value and location from the image and add it to the wavelet transform. The remainder of this image is used as the starting image for the next loop while the wavelet transform acts as an accumulator adding more and more small circular wavelets together creating a larger matched wavelet. If the correlation of original and matched wavelet reaches the maximum desired percentage(FIG. 24 Reference 22) goto step 19.

Step 3 (FIG. 24 Reference 5): Inner Loop

For each coefficient in the outer loop we must loop through all the possible wavelet scales (specified through MINSCALE,MAXSCALE and STEP) to determine the scale that has the greatest effect. If we have looped through all the scales for the current coefficient go to step 15.

Step 4 (FIG. 24 Reference 8): Determine method of choosing coefficients

If the current scale wavelet is smaller than a determined scale (baseScale) calculate coefficients in a straightforward manner (go to Step 5) otherwise we will shrink the current remainder and the wavelet to speed up the process and get an approximate location of the maximum. We then return to the current remainder and calculate more exact values in the area that we have determined the true max lies. (go to Step 6)

Step 5 (FIG. 24 Reference 12):

Convolve the circular wavelet at the current scale with the current remainder and store in templmg. (goto Step 13)

Step 6 (FIG. 24 Reference 6):

Shrink the remainder by the ratio of baseScale over the current scale.

Step 7 (FIG. 24 Reference 9):

Convolve the new shrunken remainder with the wavelet at baseScale.

Step 8 (FIG. 24 Reference 11):

Find the location of the maximum coefficient in the shrunken transform.

Step 9 (FIG. 24 Reference 14):

Scale the location of the max to its location in the large remainder image.

Step 10 (FIG. 24 Reference 15):

Calculate a window of interest around this point based on the resize ratio that was used to find the location. This is to account for location error caused by the scaling back up. This window should contain all the points that may contain the true maximum associated with the maximum found in the shrunken image.

Step 11 (FIG. 24 Reference 17):

Convolve an area around that window with the true wavelet at the current scale such that the valid return of that convolution is an area the size of the determined window.

Step 12 (FIG. 24 Reference 20):

Find the location and value of the max in this window and adjust our estimated values to the new corrected values.

Step 13 (FIG. 24 Reference 19):

Store the location and and value of the maximum determined from the process for the current scale.

Step 14 (FIG. 24 Reference 18):

Increment curScale and goto Step 3

Step 15 (FIG. 24 Reference 7):

After the maximum value for each scale has been determined for the current coefficient, we choose the maximum of all of these and this will be the coefficient we will use.

Step 16 (FIG. 24 Reference 10):

Call Invone2 with the information for the chosen coefficient. This will create an image to subtract from the original which consists of a wavelet at the determined scale and location multiplied by the determined value.

Step 17 (FIG. 24 Reference 13):

Subtract the subtraction image from remainder to create a new remainder.

Step 18 (FIG. 24 Reference 16):

Calculate the correlation percentage between the original image and the matched wavelet (orig-rem). Go to step 2

Step 19 (FIG. 24 Reference 21): return matched wavelet (original-remainder)

Apply filter to samples

The matched wavelet can now be applied to individual images for analysis or to groups of images for processing by the UFENET.

Once we have our samples and our filter we apply the filter to each sample by rotating the filter 180 degrees and convolving it (2D correlation) with each image. Each wavelet transform returned by this process is then reshaped to a one-dimensional vector, and they are all grouped together into a matrix for use with the UFENET. Each row in the matrix is the one-dimensional version of the wavelet transform for a single sample. Thus if there are 40 samples and each wavelet transform is N² then the resulting matrix is 40×N². Sometimes it is desirable to apply multiple matched filters to the samples in parallel. In such a situation, if there are 40 samples and the first wavelet transform is N² pixels and the second is M² pixels then the resulting matrix is 40×(N²+M²).

### UFENET Training and/or Feature Extraction

Once we have our matrix (we will call it d) we can use the UFENET (described below) to reduce the dimensionality of the data. Instead of dealing with N² values per sample a UFENET with b neurons will reduce the number of values per sample to b. We can then use a smaller number of features to classify our samples. The output of training is an array of weights that when applied to our matrix d, will give us a new matrix of fewer dimensions.

Function TrainUFENET

Input and Configuration Parameters:

Seqv—the input vectors

LOOPNUM—maximum number of iterations

Alpha—the alpha parameter to the sigmoid function

NumNeuron—the number of neurons to build

LnRate—the learning rate

Eta—a constant for lateral inhibitory

NormalizeNeurons—a flag: 1 if the neurons should be normalized before starting

Output Parameters:

m—the vectors of the BCM neurons

Step 1:

Prepare the input matrix(d) in which each row represents an input

Step 2:

Set the sample number as the height of d

Step 3:

Set the vector length (VECTlen) as the width of d

Step 4:

Build the lateral inhibitory matrix MAT as the matrix of size NumNeuron×NumNeuron where the diagonal elements are 1 and the other elements are -eta

Step 5:

Set m to be a random matrix of size numNeuron×VECTlen where Max(m)<=1 and Min(m)>=−1

Step 6:

If the flag normalizeNeurons is 0 goto step 8

Step 7:

Normalize each row of m

Step 8:

Initialize the index ii=1;

Step 9:

If ii>LOOPNUM goto Step 21

Step 10:

Randomly select an integer sel, ranging from 1 to SAMPnum

Step 11:

Set dt as the sel-th row of d

Step 12:

Compute the activity matrix cks of each input vectors paired with each neuron, cks=m*d′, the matrix multiplication of the neuron matrix m with the transpose of the input matrix d

Step 13:

Compute the inhibited activities matrix ckbars of all the input and all the neurons ckbars=sigmoid(Mat*cks,alpha), sigmoidal transforming the product of the lateral inhibitory matrix with the activity matrix cks.

Step 14:

Set the current inhibited activity ckbar as the sel-th column ckbars(:,sel) of the whole inhibited activities matrix ckbars.

Step 15:

Compute the threshold theta as the mean of the activity matrix ckbars.

Step 16:

Compute phi as ckbar pointwisely multiple with the difference of ckbar subtracting theta.

Step 17:

Compute the current increment factor Inc as the product of three factors: the learning rate InRate, the function phi from step 16, and a term for lateral inhibition, which is obtained from Mat times dsigmoid(ckbar,alpha), where dsigmoid is the derivative of the sigmoid function in step 13.

Step 18:

Obtain the current neurons by adding the increment Inc*dt to the old m

Step 19:

Increment ii to ii+1

Step 20:

Go to Step 9

Step 21:

Return m, the trained neurons.

Classification

Lastly, we can directly analyze the output of the UFENET or if desired we can feed this data to a classification system such as a back-propagation neural network to classify the samples.

### Additional Functions Used

function convoneAc

Input Parameters:

img—the image

r—the row at which we do convone

c—the column at which we do convone

rsize—floor of the radius of the wavelet

xx—the wavelet to convone with

Output:

v1—the convolution of the wavelet and the (2*rsize+1) area of img centered at (r,c) returns only those parts of the convolution that are computed without padding

function invone2

Input Parameters:

s1—the height of desired output

s2—the width of desired output

r—the row the coefficient should be centered on

c—the column the coefficient should be centered on

m—the value of the coefficient at r,C

wy—floor of the radius of the wavelet -y direction

wx—floor of the radius of the wavelet -x direction

xx—the wavelet to convolve with

Output:

invimg—the inverse of a single coefficient

Step 1:

Set invimg=zeros(s1,s2)

Step 2:

Set the area of invimg centered at (r,c) and the size of (2*wy+1,2*wx+1)=m*xx;

Step 3:

Return invimg

function ccmex

Input Parameters:

a—the scale of the desired 2D circularly symmetric wavelet to return

Output Parameters:

x—the 2D circularly symmetric wavelet of scale a

Step 1: General Initialization

a) Set err = 1.0e−1 a
b) Set w = 64
c) S dt = 64
d) Set step = 1
e) Set tx = a
f) Set ty = a

Step 2:

If Step > 6 Goto Step 11

Step 3:

Set dt = dt/2

Step 4:

Set t = w/10

Step 5:

If abs((1-(t/a)\hat{ }2)*exp(-(t/a)\hat{ }abs(a)) >= err Goto Step 8

Step 6:

Set w = w-dt

Step 7:

Goto Step 9

Step 8:

Set w = w+dt

Step 9:

Set Step = Step + 1

Step 10:

Goto Step 2

Step 11:

Set x = zeros(2*w+1,2*w+1 )

Step 12:

If tx > w Goto 24

Step 13:

If Ty > w Goto 22

Step 14:

Set t=sqrt(tx“2+ty”2)/1 a

Step 15:

Set tem=(1-(t/a)“2)*exp( -(t/a)”2)/sqrt(25*pi)/a

Step 16:

x(w+1+tx,w+1+ty)=tem

Step 17:

x(w+1-tx,w+1+ty)=tem

Step 18:

x(w+1-tx,w+1-ty)=tem

Step 19:

x(w+1+tx,w+1-ty)=tem

Step 20:

Set ty = ty+1

Step 21:

Goto Step 13

Step 22:

Set tx = tx+1

Step 23:

Goto Step 12

Step 24:

Return x

### Conclusion, Ramifications, and Scope of Invention

From the above descriptions, figures and narratives, the invention's advantages in matching images to known images should be clear.

Although the description, operation and illustrative material above contain many specificities, these specificities should not be construed as limiting the scope of the invention but as merely providing illustrations and examples of some of the preferred embodiments of this invention. For example, the invention may be used to analyze photographs to extract key information for satellite surveillance. A wavelet of a desired object, such as a missel emplacement or a ship could be used to detect missels or ships in a photo. The wavelet could also be applied to locate tumors or other bodily anomalies in x-rays. It is further useful as a tool for non-destructive inspection. As shown above, a ordinance such as an artillery shell can be x-rayed and evaluated without disassembly. Another use is in airport inspection stations. An x-ray image of suitcase may be quickly transformed to locate one or more contraband items, such as weapons or illegal substance.

Thus the scope of the invention should be determined by the appended claims and their legal equivalents, rather than by the examples given above.

1. A method for applying one or more daughter wavelets to an image signal, wherein each daughter wavelet is derived from a mother wavelet characterized by two dimensional circularly symmetry and constructed in accordance with the following formula:
$${h}_{a} ( x , y ) = \frac{1 - ( {x}^{2} + {y}^{2} ) / 100 {a}^{2}}{5 \sqrt{π} \cdot α} {ⅇ}^{- ( {x}^{2} + {y}^{2} ) / 100 {a}^{2}}$$

2. A method for matching a target image to one or more reference images, comprising the steps of:
selecting a plurality of samples of the reference images;
creating a filter wavelet corresponding to a matched circular symmetric two dimensional wavelet of the sample images;
varying the scale of the filter wavelet and applying a plurality of the scaled filter wavelets to a target image;
generating a plurality of convolution coefficients from the target image and the scaled filter wavelets;
selecting a coefficient with the largest absolute value and storing it with the scale of the filter wavelet that produced it;
subtracting from the image the largest coefficient and adding the subtracted image portion to an accumulator;
repeating the above steps until a maximum number of coefficients is reached or correlation between the image and the matched wavelet exceeds a threshold.

3. The method of claim claim 2 wherein the two dimensional circular symmetric daughter wavelets are derived from a mother wavelet constructed in accordance with the following formula:
$${h}_{a} ( x , y ) = \frac{1 - ( {x}^{2} + {y}^{2} ) / 100 {a}^{2}}{5 \sqrt{π} \cdot α} {ⅇ}^{- ( {x}^{2} + {y}^{2} ) / 100 {a}^{2}}$$

4 A method of filtering a target image with a plurality of scaled matching two dimensional circular symmetric filter wavelets to determine the correlation between the filter wavelets and the target image comprising the steps of:
applying a number of different-scale two dimensional circular symmetric daughter wavelets to a reference image to produce a pool of coefficients,
choosing a coefficient from the pool that has the greatest absolute value,
storing the chosen coefficient and the scale of the wavelet that produced it,
subtracting from the original image a scaled two dimensional circular symmetric daughter wavelet equal to the chosen coefficient multiplied by a two dimensional circular symmetric daughter wavelet (of the stored scale),
adding the scaled two dimensional circular symmetric daughter wavelet to an accumulator image (the matched wavelet),
calculating the correlation between the original image and the accumulator image,
repeating all said steps until either the maximum number of coefficients is reached or the correlation between the original image or the matched wavelet is above a desired level.

5. The method of claim 4, wherein the step of applying a number of different-scale wavelets to the base image further comprises the steps of:
testing the scale of the two dimensional circular symmetric daughter wavelet to determine whether it is above a base threshold, and if the scale of the wavelet is above the base threshold,
shrinking the image,
applying a smaller two dimensional circular symmetric daughter wavelet,
getting an approximate maximum,
choosing which scale will produce the maximum,
performing convolution in the desired location only.

6. The method of claim 4, wherein the step of calculating the correlation between the original image and the accumulator image further comprises the step of producing a dot product of wavelet-predicted pixels versus image pixels.

7. The method of claim 4, wherein the original pixel image comprises a textured portion of a second pixel image.

8. The method of claim 7, wherein the textured portion of the original pixel image is subtracted from the whole original pixel image to produce a new original pixel image.

9. A method for generating a matching wavelet of a reference pixel image, comprising the steps of:
applying a number of different-scale two dimensional circular symmetric daughter wavelets to the reference image to produce a pool of convolution coefficients,
from the pool of coefficients selecting the coefficient of greatest absolute value,

10. The method of claim 9 wherein the two dimensional circular symmetric daughter wavelets are derived from a mother wavelet constructed in accordance with the following formula:
$${h}_{a} ( x , y ) = \frac{1 - ( {x}^{2} + {y}^{2} ) / 100 {a}^{2}}{5 \sqrt{π} \cdot α} {ⅇ}^{- ( {x}^{2} + {y}^{2} ) / 100 {a}^{2}}$$

11. The method of claim 9 comprising further steps to estimate a maximum coefficient:
shrinking the image by a first factor, r do derived a shrunken image;
convolving the shrunken image with one scale factor, a, to derive a coefficient matrix;
restoring the shrunken image to its original size and then convolving the original image with the derived coefficient matrix.

12. The method of claim 9 comprising further steps to estimate a maximum coefficient with speed and accuracy:
shrinking the image by a first factor, r do derived a shrunken image;
convolving the shrunken image for all scale factors to derive an estimated coefficient matrixes at all scales;
select the scale value and it shift position of the maximum coefficient;
convolve the value of the inner product to determine one estimated maximum coefficient.

13. The method of claim 14 wherein the step of calculating the correlation between the original image and the accumulator image further comprises the step of producing a dot product of wavelet-predicted pixels versus image pixels.

14. The method of claim 9, wherein the step of applying a number of different-scale wavelets to the reference image further comprises the steps of:
testing the scale of the two dimensional circular symmetric daughter wavelet to determine whether it is above a base threshold, and if the scale of the wavelet is above the base threshold,
shrinking the image,
applying a smaller two dimensional circular symmetric daughter wavelet,
getting an approximate maximum,
choosing which scale will produce the maximum,
performing convolution in the desired location only.

15. Claim y002x. A method for matching a target image to one or more reference images, comprising the steps of:
generating a filter wavelet from the reference image(s);
wavelet tranforming the target image with the filter wavelet to obtain a wavelet transform for each known image;
reshaping each wavelet transform for a known image to a one-dimensional vector,
grouping all one-dimensional vectors into a matrix wherein each row in the matrix is the one-dimensional version of the wavelet transform for a single known image,
selecting a lower-dimensional projection of the combined wavelet function with a maximized projection index,
finding a plurality of lower-dimensional projections of the combined wavelet functions,
comparing the lower-dimensional projections of the combined wavelet function for the new image to one or more lower-dimensional projections of combined wavelet functions for known images, to find one or more known images matching the original unknown image.

16. The method of claim 15 wherein the filter wavelet is a two dimensional circular symmetric daughter wavelets are derived from a mother wavelet constructed in accordance with the following formula:
$${h}_{a} ( x , y ) = \frac{1 - ( {x}^{2} + {y}^{2} ) / 100 {a}^{2}}{5 \sqrt{π} \cdot α} {ⅇ}^{- ( {x}^{2} + {y}^{2} ) / 100 {a}^{2}}$$

16. The method of claim 15 wherein the step of applying a filter wavelet to each known image further comprises the steps of:
rotating the filter 180 degrees,
convolving the filter with the known image.

17. The method of claim 15 wherein the step of selecting a lower-dimensional projection of the combined wavelet function with a maximized projection index further comprises the step of performing exploratory projection pursuit using Bienenstock, Cooper and Munro (BCM) neurons.

18. The method of claim 15 wherein the step of finding a plurality of lower-dimensional projections of the combined wavelet function further comprises the step of applying a network of parallel BCM neurons concurrently to multiple combined wavelet functions to find a plurality of lower-dimensional projections of the combined wavelet functions.

19. The method of claim 15 further comprising the step of using a back-propagation network of neurons to find lower-dimensional projections of the combined wavelet function automatically.

20. A computer program stored on a machine readable medium for operating a computer to carry out steps comprising:
generating two dimensional symmetric mother wavelet and a plurality of daughter wavelets matched to a a reference image;
applying the two dimensional circular symmetric daughter wavelets to a target image to produce a pool of coefficients,
choosing a coefficient from the pool that has the greatest absolute value, storing the chosen coefficient and the scale of the wavelet that produced it, subtracting from the target image a scaled two dimensional circular symmetric daughter wavelet equal to the chosen coefficient multiplied by a two dimensional circular symmetric daughter wavelet (of the stored scale), and adding the scaled two dimensional circular symmetric daughter wavelet to an accumulator image (the matched wavelet),
correlating the original image and the accumulator image until either the maximum number of coefficients is reached or the correlation between the original image and the matched wavelet is above a desired level.

21. The computer program of claim 20 wherein the reference image comprises a textured portion of the image.

22. A computer for matching a new image signal to one or more known image signals, comprising:
a processor;
a main memory connected to the processor, for the execution of software programs;
a mass storage subsystem connected to the processor, for the storage of software programs and data;
a display subsystem connected to the processor;
a data entry subsystem connected to the processor;
an input device for entering commands and data, an output device for displaying results, one or more processors for executing commands; one or more memory units for holding programs and data;
a software program stored in one of the memory units for operating the computer to perform the following steps:
matching a plurality of two dimensional circular symmetric daughter wavelets to an original pixel image to produce a single combined matched wavelet,
applying a filter wavelet generated from the new image to each known image to obtain a wavelet transform for each known image,
constructing a lower-dimensional projection of the combined wavelet function with a maximized projection index,
finding a plurality of lower-dimensional projections of the combined wavelet function,
comparing the lower-dimensional projections of the combined wavelet function to one or more lower-dimensional projections of combined wavelet functions for known images, to find one or more known images matching the original unknown image.

23. The computer of claim 18 wherein the two dimensional circular symmetric daughter wavelets are derived from a mother wavelet constructed in accordance with the following formula:
$${h}_{a} ( x , y ) = \frac{1 - ( {x}^{2} + {y}^{2} ) / 100 {a}^{2}}{5 \sqrt{π} \cdot α} {ⅇ}^{- ( {x}^{2} + {y}^{2} ) / 100 {a}^{2}}$$

24. The computer of claim 22, wherein the software program further comprises steps for:
reshaping each wavelet transform for a known image to a one-dimensional vector,
grouping all one-dimensional vectors into a matrix wherein each row in the matrix is the one-dimensional version of the wavelet transform for a single known image, and
for selecting a lower-dimensional projection of the combined wavelet function with a maximized projection index.

25. The computer of claim 22 wherein the software program for finding a plurality of lower-dimensional projections of the combined wavelet function further comprises:
a software program stored in a machine-readable medium for applying concurrently a network of parallel BCM neurons to find a plurality of lower-dimensional projections of the combined wavelet function,
a software program stored in a machine-readable medium for using a back-propagation network (BPN) of neurons to find lower-dimensional projections of the combined wavelet function automatically.

26. The computer of claim 22 wherein the software program for matching a plurality of two dimensional circular symmetric daughter wavelets to an original pixel image to produce a single combined matched wavelet further comprises instructions for performing the following steps:
applying a number of different-scale two dimensional circular symmetric daughter wavelets to the base image to produce a pool of coefficients,
selecting the one coefficient from the pool that has the greatest absolute value, storing the chosen coefficient and the scale of the wavelet that produced it, subtracting from the base image a scaled two dimensional circular symmetric daughter wavelet equal to the chosen coefficient multiplied by a two dimensional circular symmetric daughter wavelet (of the stored scale), and adding the scaled two dimensional circular symmetric daughter wavelet to an accumulator image (the matched wavelet),
calculating the correlation between the original image and the accumulator image, until either the maximum number of coefficients is reached or the correlation between the original image and the matched wavelet is above a desired level.

27. The computer of claim 22 wherein the original pixel image comprises a textured portion of a second pixel image.

28. An image processing apparatus for matching a target image to one or more reference images, comprising:
means for deriving a two dimensional circular symmetric mother wavelet and a family of two dimensional circular symmetric daughter wavelets from one or more reference images of an object to provide a filter wavelet;
means for applying the filter wavelet to a target image to obtain a wavelet transform for the target image;
means for constructing a lower-dimensional projection of the combined wavelet function with a maximized projection index,
means for finding a plurality of lower-dimensional projections of the combined wavelet function,
means for comparing the lower-dimensional projections of the combined wavelet function to one or more lower-dimensional projections of combined wavelet functions for known images, to find one or more known images matching the original unknown image.

29. The image processing apparatus of claim 28 wherein the two dimensional circular symmetric daughter wavelets are derived from a mother wavelet constructed in accordance with the following formula:
$${h}_{a} ( x , y ) = \frac{1 - ( {x}^{2} + {y}^{2} ) / 100 {a}^{2}}{5 \sqrt{π} \cdot α} {ⅇ}^{- ( {x}^{2} + {y}^{2} ) / 100 {a}^{2}}$$

30 The apparatus of claim 28, wherein the means for constructing a lower-dimensional projection of the combined wavelet function (with a maximized projection index) further comprises:
means for reshaping each wavelet transform for a known image to a one-dimensional vector,
means for grouping all one-dimensional vectors into a matrix wherein each row in the matrix is the one-dimensional version of the wavelet transform for a single known image,
means for selecting a lower-dimensional projection of the combined wavelet function with a maximized projection index.

31. The apparatus of claim 28 wherein the software program for finding a plurality of lower-dimensional projections of the combined wavelet function further comprises:
means for applying concurrently a network of parallel BCM neurons to find a plurality of lower-dimensional projections of the combined wavelet function,
means for using a back-propagation network (BPN) of neurons to find lower-dimensional projections of the combined wavelet function automatically.

32. The apparatus of claim 28, wherein the means for generating a matching two dimensional circular symmetric daughter wavelet from reference pixel images further comprises:
means for applying a number of different-scale two dimensional circular symmetric daughter wavelets to the reference image(s) to produce a pool of coefficients,
means for choosing the one coefficient from the pool that has the greatest absolute value, storing the chosen coefficient and the scale of the wavelet that produced it.

33. The apparatus of claim 32 further comprising:
means for subtracting from the target image scaled two dimensional circular symmetric daughter filter wavelets equal to the chosen coefficient multiplied by a two dimensional circular symmetric daughter wavelet (of the stored scale), and adding the scaled two dimensional circular symmetric daughter wavelet to an accumulator image (the matched wavelet),
means for calculating the correlation between the reference target image and the accumulator image, until either the maximum number of coefficients is reached or the correlation between the original image and the matched wavelet is above a desired level.

34. The apparatus of claim 28, wherein the reference pixel image comprises a textured portion of a second pixel image.
